(19) United States
(12) Patent Application Publication
(10) Pub. No.: US 2017/0066354 A1
(43) Pub. Date: Mar. 9, 2017

(54) SEAT FOR MEANS OF TRANSPORT AND CUSHION THAT CAN BE COUPLED TO THE SEAT

(71) Applicant: AVIOINTERIORS S.P.A., Napoli (IT)

(72) Inventor: Alberto VENERUSO, Napoli (IT)

(21) Appl. No.: 15/260,811

(22) Filed: Sep. 9, 2016

(30) Foreign Application Priority Data
Sep. 9, 2015 (IT) 202015000050086

(51) Int. Cl. B60N 2/48; B61D 33/00; B64D 11/06

(52) U.S. Cl. CPC B60N 2/4879; B64D 11/0642; B61D 33/005; B61D 33/0035

(57) ABSTRACT

The present invention concerns a seat (1) for means of transport, such as aircraft, trains and the like, of the type arranged in series to the other seats (1) so as to form a column, comprising a base portion (11) for the seat of a passenger, a backrest (12), having a first and a second end, said first end being fixed to said base portion (11), a headrest (13) fixed to said second end of said backrest (12), or integrated in said backrest (12), said headrest (13) having a front surface (131), on which the passenger sitting on said base portion (11) can lay his own head, and a rear surface (132), opposite to said front surface (131) and facing a further seat (2) placed in the column behind said seat (1), when said seat (1) is arranged in a column.

The present invention relates to a seat for means of transport.

The present invention relates also a cushion that can be coupled to the seat for means of transport.

More specifically, the invention relates to a seat for means of transport of the above kind and a cushion that can be coupled to it, studied and realized in particular for allowing the rest of the passengers on airplanes, trains, buses and the like, but which can be used for any other means of transport.

In the following, the description will be directed to the seats of an airplane, but it is clear that it should not be considered limited to this specific use.

As it is well known, seats currently on means of transport and in particular on aircrafts, comprise a seat base, a portion for the support of the passenger's lumbar region, also known as a backrest, and a portion for the support of the head, also known as headrest.

The headrest has a front surface, for supporting the head of the passenger seated in the seat base.

Usually in the seats currently in use, the front surface of the headrest includes a cushion to make more comfortable the staying of the passenger sitting in the seat, while the back surface is rigid or flat or may have housings for monitors or display devices.

Often, however, maintaining the same position for the rest can be tiring.

In the light of the above, it is, therefore, object of the present invention providing a solution that allows a passenger to change the rest position.

In is therefore specific object of the present invention a seat for means of transport, such as aircraft, trains and the like, of the type arranged in series to the other seats so as to form a column, comprising a base portion for the seat of a passenger, a backrest, having a first and a second end, said first end being fixed to said base portion, a headrest fixed to said second end of said backrest, or integrated in said backrest, said headrest having a front surface, on which the passenger sitting on said base portion can lay his own head, and a rear surface, opposite to said front surface and facing a further seat placed in the column behind said seat, when said seat is arranged in column, said seat being characterized in that a supporting element is arranged on said rear surface for supporting the head of a passenger.

Further according to the invention, said supporting element is made of soft deformable material.

Preferably according to the invention, said supporting element is a cushion, a padding or the like.

Still according to the invention, said supporting element is anatomically shaped, having a concave shape.

Further according to the invention, said supporting element is removably coupled with said rear surface of said seat.

Preferably according to the invention, said supporting element is coupled by means of coupling means, such as Velcro®, laces and the like with said rear surface of said seat.

Preferred embodiments are defined in the dependent claims.

It is further object of the present invention a cushion for a seat for means of transport, such as aircraft, trains and the like, said seat being of the type comprising a headrest having a front surface, on which the head of a passenger sitting on said seat can be rested, and a rear surface, opposite to said front surface, said cushion being characterized in that it comprises coupling means for the removable coupling with said rear surface of said seat.

Still according to the invention, said cushion can be made of soft deformable material, and can be anatomically shaped, having a central concave shape.

Further according to the invention, said coupling means are Velcro®, laces and the like.

The present invention will be now described, for illustrative but not limitative purposes, according to its preferred embodiments, with particular reference to the figures of the enclosed drawings, wherein:

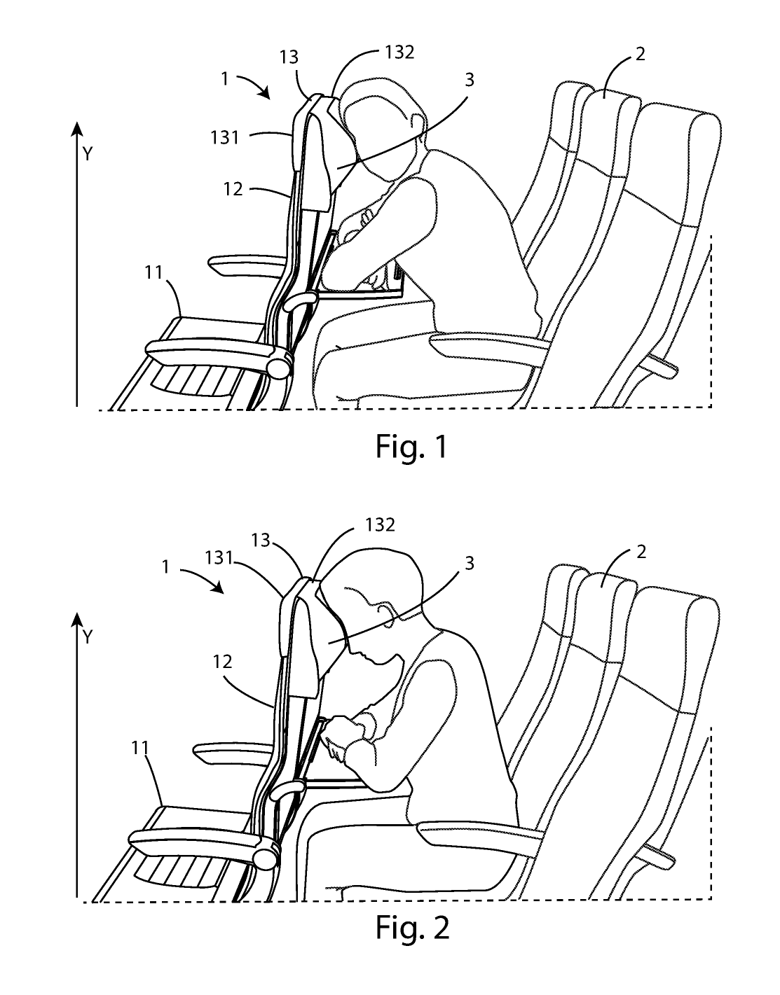

FIG. 1 shows a side view of the seat for means of transport object of the present invention;

FIG. 2 shows a further side view of the seat of FIG. 1;

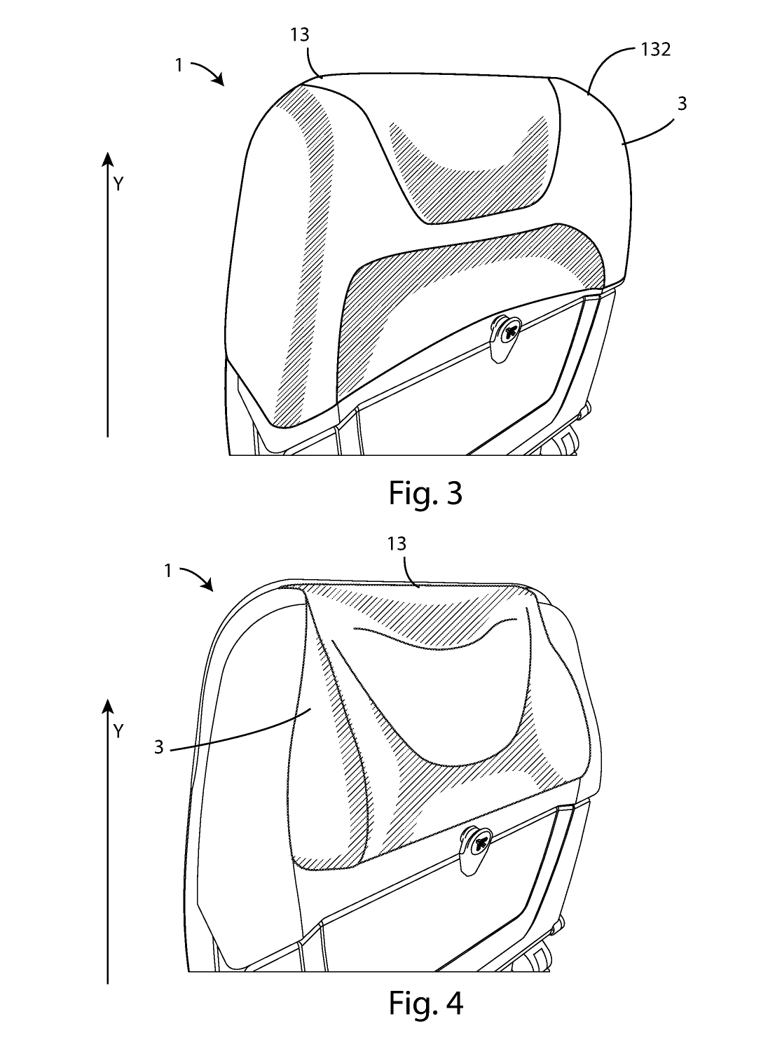

FIG. 3 shows a perspective rear view of a detail of the seat of FIG. 1;

FIG. 4 shows a perspective rear view of a further detail of the seat of FIG. 1; and

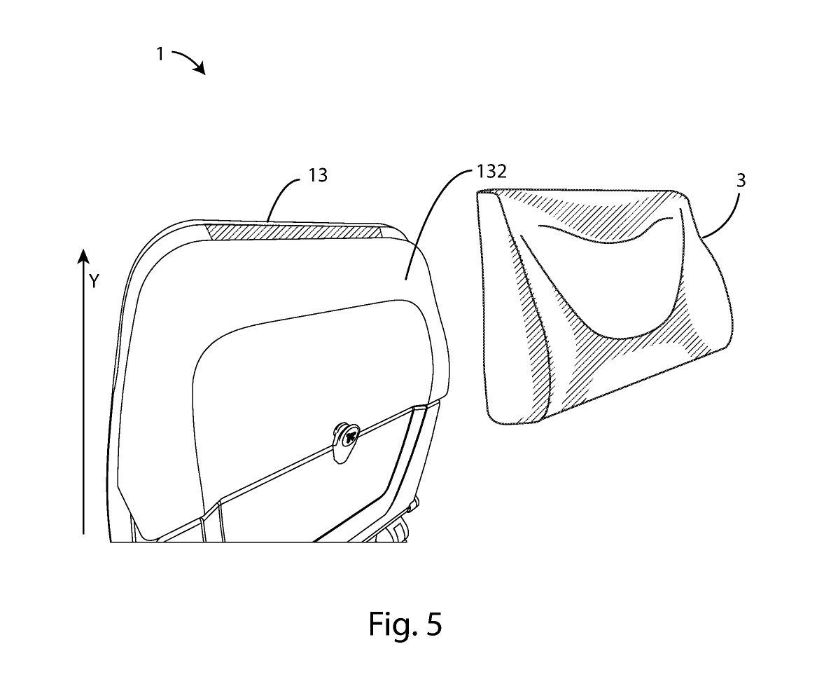

FIG. 5 shows a perspective rear view of a second embodiment of the seat object of the present invention.

In the various figures, similar parts will be indicated by the same reference numbers.

Referring to FIGS. 1 and 2, a first seat 1 for means of transport can be seen, in particular an aircraft, object of the present invention.

Said seat 1 is of the type arranged in series to the other seats 1 of the same type, so as to form a column. In other words, in the following column means a set of consecutive seats 1, the one arranged in front of the other, so that the passenger sitting on a seat 1 has in the front the rear part of the seatback of the seat in front belonging to the same column.

Said seat 1 comprises a seat base or base portion for the seat of a passenger, indicated by reference number 11, a backrest 12, having a first and a second end, which develops according to a direction Y.

Said first end of said backrest 12 is fixed on said seat 11.

Said first seat 1 also comprises a headrest 13, fixed on said second end of said backrest 12.

Said headrest 13 has a front surface 131 and a rear surface 132, opposite to said front surface 131 and facing towards a second seat 2, arranged in column behind said first seat 1.

Said front surface 131 is the one, on which the passenger sitting on said seat portion 11 of said first seat 1 rests his head.

Said rear surface 132 faces a second seat 2 in column, placed behind said first seat 1.

Said seat 1 also comprises a support element, which is a cushion 3 in the embodiment.

Said cushion 3 is positioned on the rear surface 132 of said headrest 13 and has an anatomic shape that conforms to the head, particularly to the front of the passenger occupying the second seat 2.

In particular, said cushion 3 has a concavity facing upwards, towards the passenger occupying said second seat 2. Said cushion 3, also, has an upwards tapered shape.

In a first implementing variant, said cushion 3 is integrated in said headrest 13.

In a second implementing variant, instead, said cushion 3 is removably coupled with said rear surface 132 of said headrest 13 of the seat 1, by means of said first coupling means such as Velcro®, laces and the like.

Said cushion 3 is made of a deformable soft material, in order to make more comfortable the rest of said passenger occupying said second seat 2. Particularly, said cushion 3 can be padded with different known materials.

As it is obvious from the above description, the seat of the present invention allows a passenger occupying a seat of a means of transport to lean on the front seat on a surface anatomically shaped, to accommodate the front of the passenger.

The present invention has been described for illustrative but not limitative purposes, according to its preferred embodiments, but it is to be understood that modifications and/or changes can be introduced by those skilled in the art without departing from the relevant scope as defined in the enclosed claims.

1. Seat (1) for means of transport, such as aircraft, trains and the like, of the type arranged in series to the other seats (1) so as to form a column, comprising
a base portion (11) for the seat of a passenger,
a backrest (12), having a first and a second end, said first end being fixed to said base portion (11),
a headrest (13) fixed to said second end of said backrest (12), or integrated in said backrest (12), said headrest (13) having a front surface (131), on which the passenger sitting on said base portion (11) can lay his own head, and a rear surface (132), opposite to said front surface (131) and facing a further seat (2) placed in the column behind said seat (1), when said seat (1) is arranged in column,
said seat (1) being characterized in that a supporting element (3) is arranged on said rear surface (132) for supporting the head of a passenger.

2. Seat (1) according to claim 1, characterized in that said supporting element (3) is made of soft deformable material.

3. Seat (1) according to claim 1, characterized in that said supporting element (3) is a cushion, a padding or the like.

4. Seat (1) according to claim 1, characterized in that said supporting element (3) is anatomically shaped, having a concave shape.

5. Seat (1) according to claim 1, characterized in that said supporting element (3) is removably coupled with said rear surface (132) of said seat (1).

6. Seat (1) according to claim 5, characterized in that said supporting element (3) is coupled by means of coupling means, such as Velcro®, laces and the like with said rear surface (132) of said seat (1).

7. Cushion (3) for a seat for means of transport, such as aircraft, trains and the like, said seat being of the type comprising a headrest having a front surface, on which the head of a passenger sitting on said seat can be rested, and a rear surface, opposite to said front surface, said cushion being characterized
in that it comprises coupling means for the removable coupling with said rear surface of said seat.

8. Cushion (3) according to claim 7 characterized
in that it is made of soft deformable material, and
in that it is anatomically shaped, having a central concave shape.

9. Cushion (3) according to claim 7, characterized in that said coupling means are Velcro®, laces and the like.
